(19) United States
(12) Patent Application Publication
(10) Pub. No.: US 2023/0396405 A1
(43) Pub. Date: Dec. 7, 2023

(54) Polarization Encoding for High-Density 5G/6G Communication

(71) Applicants: David E. Newman, Palos Verdes, CA (US); R. Kemp Massengill, Palos Verdes, CA (US)

(72) Inventors: David E. Newman, Palos Verdes, CA (US); R. Kemp Massengill, Palos Verdes, CA (US)

(21) Appl. No.: 17/728,458

(22) Filed: Apr. 25, 2022

Related U.S. Application Data
(60) Provisional application No. 63/210,216, filed on Jun. 14, 2021.
(60) Provisional application No. 63/214,489, filed on Jun. 24, 2021.
(60) Provisional application No. 63/220,669, filed on Jul. 12, 2021.
(60) Provisional application No. 63/234,911, filed on Aug. 19, 2021.
(60) Provisional application No. 63/272,352, filed on Oct. 27, 2021.
(60) Provisional application No. 63/313,380, filed on Feb. 24, 2022.
(60) Provisional application No. 63/321,879, filed on Mar. 21, 2022.
(60) Provisional application No. 63/327,005, filed on Apr. 4, 2022.
(60) Provisional application No. 63/327,007, filed on Apr. 4, 2022.
(60) Provisional application No. 63/329,599, filed on Apr. 11, 2022.

(51) Int. Cl. H04L 5/04

(52) U.S. Cl. CPC H04L 5/04

(57) ABSTRACT

Wireless messages in 5G and 6G are generally transmitted on one polarization orientation, the vertical orientation, while the horizontal polarization is generally unused. Disclosed are modulation schemes and systems for encoding additional information in the horizontal polarization signal as well as the vertical, thereby providing faster and more compact messaging. Also disclosed are short-form polarization-demodulation references that exhibit the maximum and minimum amplitude levels of the modulation scheme, in the vertical and horizontal polarizations separately, while the other polarization is silent. The receiver can thereby measure and correct for crosstalk between the polarization components. The demodulation reference may also include a gap of zero transmission, enabling background evaluation. By comparing the modulation values of message elements to the predetermined levels exhibited in the polarization-demodulation reference, the receiver can demodulate the message while mitigating noise, interference, and crosstalk, according to some embodiments.

### PRIORITY CLAIMS AND RELATED APPLICATIONS

This application claims the benefit of U.S. Provisional Patent Application Ser. No. 63/210,216, entitled “Low-Complexity Access and Machine-Type Communication in 5G”, filed Jun. 14, 2021, and U.S. Provisional Patent Application Ser. No. 63/214,489, entitled “Low-Complexity Access and Machine-Type Communication in 5G”, filed Jun. 24, 2021, and U.S. Provisional Patent Application Ser. No. 63/220,669, entitled “Low-Complexity Access and Machine-Type Communication in 5G”, filed Jul. 12, 2021, and U.S. Provisional Patent Application Ser. No. 63/234,911, entitled “Short Demodulation Reference for Improved Reception in 5G”, filed Aug. 19, 2021, and U.S. Provisional Patent Application Ser. No. 63/272,352, entitled “Sidelink V2V, V2X, and Low-Complexity IoT Communications in 5G and 6G”, filed Oct. 27, 2021, and U.S. Provisional Patent Application Ser. No. 63/313,380, entitled “Short-Form 5G/6G Pulse-Amplitude Demodulation References”, filed Feb. 24, 2022, and U.S. Provisional Patent Application Ser. No. 63/321,879, entitled “Low-Complexity Demodulation of 5G and 6G Messages”, filed Mar. 21, 2022, and U.S. Provisional Patent Application Ser. No. 63/327,005, entitled “Recovery and Demodulation of Collided 5G/6G Message Elements”, filed Apr. 4, 2022, and U.S. Provisional Patent Application Ser. No. 63/327,007, entitled “Modulation Including Zero-Power States in 5G and 6G”, filed Apr. 4, 2022, and U.S. Provisional Patent Application Ser. No. 63/329,599, entitled “Polarization Encoding for High-Density 5G/6G Communication”, filed Apr. 11, 2022, all of which are hereby incorporated by reference in their entireties.

### FIELD OF THE INVENTION

The disclosure pertains to wireless message modulation, and particularly to methods for encoding information in wireless signal polarization.

### BACKGROUND OF THE INVENTION

In wireless messaging, the transmission data rate is proportional to the number of bits that can be encoded in each message element. As the number of users expands due to the 5G/6G roll-out worldwide, there will be increasing pressure to make maximum use of the limited bandwidth, yet avoiding congestion and interference due to high-density environments such as urban centers and highly-automated industrial sites. What is needed is means for increasing the information density, or bits per message element, in wireless communications.

This Background is provided to introduce a brief context for the Summary and Detailed Description that follow. This Background is not intended to be an aid in determining the scope of the claimed subject matter nor be viewed as limiting the claimed subject matter to implementations that solve any or all of the disadvantages or problems presented above.

### SUMMARY OF THE INVENTION

In a first aspect, there is a method for transmitting a wireless message, the method comprising: encoding, according to a modulation scheme, a first set of bits of the message in a first polarization component; encoding, according to the modulation scheme, a second set of bits of the message in a second polarization component; transmitting the first polarization component on one or more first antenna elements; and transmitting the second polarization component on one or more second antenna elements.

In another aspect, there is non-transitory computer-readable media in a wireless receiver, the media containing instructions that when executed in a computing environment cause a method to be performed, the method comprising: providing a first antenna element for receiving radio waves with an electric field oscillation in a vertical direction, and a second antenna element for receiving radio waves with the electric field oscillation in a horizontal direction; receiving a message comprising message elements modulated according to a modulation scheme, each message element comprising a vertical polarization signal on the first antenna element and a horizontal polarization signal on the second antenna element; for each message element, measuring a first amplitude or phase value of the vertical polarization signal and a second amplitude or phase value of the horizontal polarization signal; for each message element, comparing the first amplitude or phase value to one or more predetermined amplitude or phase levels of the modulation scheme and selecting the predetermined amplitude or phase level closest to the measured first amplitude or phase value; and for each message element, comparing the second amplitude or phase value to the one or more predetermined amplitude or phase levels of the modulation scheme and selecting the predetermined amplitude or phase level closest to the measured second amplitude or phase value.

In another aspect, there is a wireless receiver, comprising a user device or a base station in signal communication with the user device, the wireless receiver configured to receive and demodulate a message by: repeatedly measuring a vertical polarization signal derived from a vertically oscillating electric field, and repeatedly measuring a horizontal polarization signal derived from a horizontally oscillating electric field; determining, from the measurements, a vertical subcarrier signal at a particular subcarrier frequency and a horizontal subcarrier signal at the particular subcarrier frequency; measuring, according to the vertical subcarrier signal, a vertical subcarrier amplitude or phase, and measuring, according to the horizontal subcarrier signal, a horizontal subcarrier amplitude or phase; and comparing the vertical subcarrier amplitude or phase to one or more predetermined amplitude or phase levels of a modulation scheme, and comparing the horizontal subcarrier amplitude or phase to the one or more predetermined amplitude or phase levels of the modulation scheme.

This Summary is provided to introduce a selection of concepts in a simplified form. The concepts are further described in the Detailed Description section. Elements or steps other than those described in this Summary are possible, and no element or step is necessarily required. This Summary is not intended to identify key features or essential features of the claimed subject matter, nor is it intended for use as an aid in determining the scope of the claimed subject matter. The claimed subject matter is not limited to implementations that solve any or all disadvantages noted in any part of this disclosure.

These and other embodiments are described in further detail with reference to the figures and accompanying detailed description as provided below.

### BRIEF DESCRIPTION OF THE DRAWINGS

FIG. 1 is a schematic showing an exemplary embodiment of a wireless message with two polarization states being received, according to some embodiments.

FIG. 2 is a schematic showing an exemplary embodiment of a resource grid with polarization-encoded messages, according to some embodiments.

FIG. 3A is a flowchart showing an exemplary embodiment of a procedure for transmitting a message with polarization encoding, according to some embodiments.

FIG. 3B is a flowchart showing an exemplary embodiment of a procedure for receiving a message with polarization encoding, according to some embodiments.

FIG. 4 is a graphic showing an exemplary embodiment of a QPSK modulation scheme with polarization encoding, according to some embodiments.

FIG. 5A is a graphic showing an exemplary embodiment of a 16QAM modulation scheme with classical amplitude-phase modulation, according to some embodiments.

FIG. 5B is a graphic showing an exemplary embodiment of a 16QAM modulation scheme with pulse-amplitude modulation, according to some embodiments.

FIG. 5C is a graphic showing an exemplary embodiment of a polarization-encoded 16QAM modulation scheme including modulation of vertical and horizontal polarizations, according to some embodiments.

FIG. 6A is a graphic showing an exemplary embodiment of a polarization-encoded 16QAM message including a demodulation reference in classical amplitude-phase modulation, according to some embodiments.

FIG. 6B is a graphic showing an exemplary embodiment of a polarization-encoded 16QAM message including a demodulation reference in pulse-amplitude modulation, according to some embodiments.

FIG. 7 is a flowchart showing an exemplary embodiment of a procedure for receiving and processing a polarization-encoded message, according to some embodiments.

Like reference numerals refer to like elements throughout.

### DETAILED DESCRIPTION

Systems and methods disclosed herein (the “systems” and “methods”, also occasionally termed “embodiments” or “arrangements” or “versions”, generally according to present principles) can provide urgently needed wireless communication protocols for transmitting messages with information encoded in both vertical and horizontal polarizations of the electromagnetic wave. Polarization encoding thereby multiplies the number of modulation states available for encoding data. Messages with both horizontal and vertical polarization states, modulated according to the message data, can thereby convey the data rapidly and compactly, within the same bandwidth and numerology as prior-art single-polarization transmissions, according to some embodiments. In addition, special polarization-demodulation references, disclosed below, can enable receivers to demodulate polarization-encoded message elements despite crosstalk between polarization states, as well as noise and interference, while also demarking the start and end of the message. Further examples disclose how polarization encoding can enable the receiver to measure and mitigate polarization crosstalk. Versions applicable to classical amplitude-phase modulation and to pulse-amplitude modulation are disclosed. With the development of higher frequency communications and beamforming in 5G and especially 6G, transmissions become increasingly “line-of-sight”, thereby making it increasingly feasible to transmit data encoded in both horizontal and vertical polarizations. As a result, networks can gain higher information density in communications, higher throughput, shorter messages for the same content, lower latency, and improved network performance generally, according to some embodiments.

Terms herein generally follow 3GPP (third generation partnership project) standards, but with clarification where needed to resolve ambiguities. As used herein, “5G” represents fifth-generation, and “6G” sixth-generation, wireless technology in which a network (or cell or LAN Local Area Network or RAN Radio Access Network or the like) may include a base station (or gNB or generation-node-B or eNB or evolution-node-B or AP Access Point) in signal communication with a plurality of user devices (or UE or User Equipment or user nodes or terminals or wireless transmit-receive units) and operationally connected to a core network (CN) which handles non-radio tasks, such as administration, and is usually connected to a larger network such as the Internet. The time-frequency space is generally configured as a “resource grid” including a number of “resource elements”, each resource element being a specific unit of time termed a “symbol period” or “symbol-time”, and a specific frequency and bandwidth termed a “subcarrier” (or “subchannel” in some references). Symbol periods may be termed “OFDM symbols” (Orthogonal Frequency-Division Multiplexing) in references. The time domain may be divided into ten-millisecond frames, one-millisecond subframes, and some number of slots, each slot including 14 symbol periods. The number of slots per subframe ranges from 1 to 8 depending on the “numerology” selected. The frequency axis is divided into “resource blocks” (also termed “resource element groups” or “REG” or “channels” in references) including 12 subcarriers, each subcarrier at a slightly different frequency. The “numerology” of a resource grid corresponds to the subcarrier spacing in the frequency domain. Subcarrier spacings of 15, 30, 60, 120, and 240 kHz are defined in various numerologies. Each subcarrier can be independently modulated to convey message information. Thus a resource element, spanning a single symbol period in time and a single subcarrier in frequency, is the smallest unit of a message. “Classical” amplitude-phase modulation refers to message elements modulated in both amplitude and phase, whereas “PAM” (pulse-amplitude modulation) refers to separately amplitude-modulating two signals and then adding them with a 90-degree phase shift. The two signals may be called the “I” and “Q” branch signals (for In-phase and Quadrature-phase) or “real and imaginary” among others. Standard modulation schemes in 5G and 6G include BPSK (binary phase-shift keying), QPSK (quad phase-shift keying), 16QAM (quadrature amplitude modulation with 16 modulation states), 64QAM, 256QAM and higher orders. Most of the examples below relate to QPSK or 16QAM, with straightforward extension to the other levels of modulation. QPSK is phase modulated but not amplitude modulated. 16QAM may be modulated according to PAM which exhibits two phase levels at zero and 90 degrees (or in practice, for carrier suppression, ±45 degrees) and four amplitude levels including two positive and two negative amplitude levels, thus forming 16 distinct modulation states. For comparison, classical amplitude-phase modulation in 16QAM includes four positive amplitude levels and four phases of the raw signal, which are multiplexed to produce the 16 states of the modulation scheme. In addition, the extremely legacy “on-off” modulation refers to transmitting message bits with amplitude modulation in which one state has zero transmission. Communication in 5G and 6G generally takes place on abstract message “channels” (not to be confused with frequency channels) representing different types of messages, embodied as a PDCCH and PUCCH (physical downlink and uplink control channels) for transmitting control information, PDSCH and PUSCH (physical downlink and uplink shared channels) for transmitting data and other non-control information, PBCH (physical broadcast channel) for transmitting information to multiple user devices, among other channels that may be in use. In addition, one or more random access channels may include multiple random access channels in a single cell. “CRC” (cyclic redundancy code) is an error-checking code. “RNTI” (radio network temporary identity) is a network-assigned user code. “SNR” (signal-to-noise ratio) and “SINR” (signal-to-interference-and-noise ratio) are used interchangeably unless specifically indicated. “RRC” (radio resource control) is a control-type message from a base station to a user device. “Digitization” refers to repeatedly measuring a waveform using, for example, a fast ADC (analog-to-digital converter) or the like. An “RF mixer” is a device for multiplying an incoming signal with a local oscillator signal, thereby selecting one component of the incoming signal. A “sum-signal” is a waveform including the combined signals from a plurality of separately modulated subcarriers.

In addition to the 3GPP terms, the following terms are defined herein. Although in references a modulated resource element of a message may be referred to as a “symbol”, this may be confused with the same term for a time interval (“symbol-time”), among other things. Therefore, each modulated resource element of a message is referred to as a “modulated message resource element”, or more simply as a “message element”, in examples below. A “demodulation reference” is a set of Nref modulated “reference resource elements” or “reference elements” modulated according to the modulation scheme of the message and configured to exhibit levels of the modulation scheme (as opposed to conveying data). Thus integer Nref is the number of reference resource elements in the demodulation reference. A “calibration set” is one or more amplitude values (and optionally phase values), which have been determined according to a demodulation reference, representing the predetermined modulation levels of a modulation scheme. Thus the receiver can determine modulation levels from one or more demodulation reference, calculate intermediate levels by interpolation if needed, and then record the modulation levels in the calibration set. Each modulation level in the calibration set may have a code or number associated with it, and the receiver can demodulate the message element by selecting the modulation level in the calibration set that most closely matches the observed modulation level of the message element, and then assigning that associated code or number to the message element. If the message element has more than one modulation level, such as amplitude and phase, then the two associated codes or numbers may be concatenated to form the demodulated message element. Generally the modulation scheme includes integer Nlevel predetermined amplitude or phase levels. “RF” or radio-frequency refers to electromagnetic waves in the MHz (megahertz) or GHz (gigahertz) frequency ranges. “Polarization” refers to the orientation of the oscillating electric field of a propagating electromagnetic wave, such as “V-mode” or vertical polarization and “H-mode” or horizontal polarization. A “short-form demodulation reference” is a compact demodulation reference exhibiting, generally, the maximum and minimum amplitude or phase levels of a polarization scheme so that the receiver can calculate other levels by interpolation. A “polarization-demodulation reference” is a demodulation reference that exhibits maximum and minimum amplitude or phase levels for each polarization state separately, so that the receiver can determine and mitigate polarization mixing that may occur in propagation. In each case, the receiver may determine the modulation levels from the polarization-demodulation reference elements and record them in the calibration set for subsequent use in demodulating the message elements.

Turning now to the figures, in a first example, polarized waveforms are introduced and detected, highly schematically.

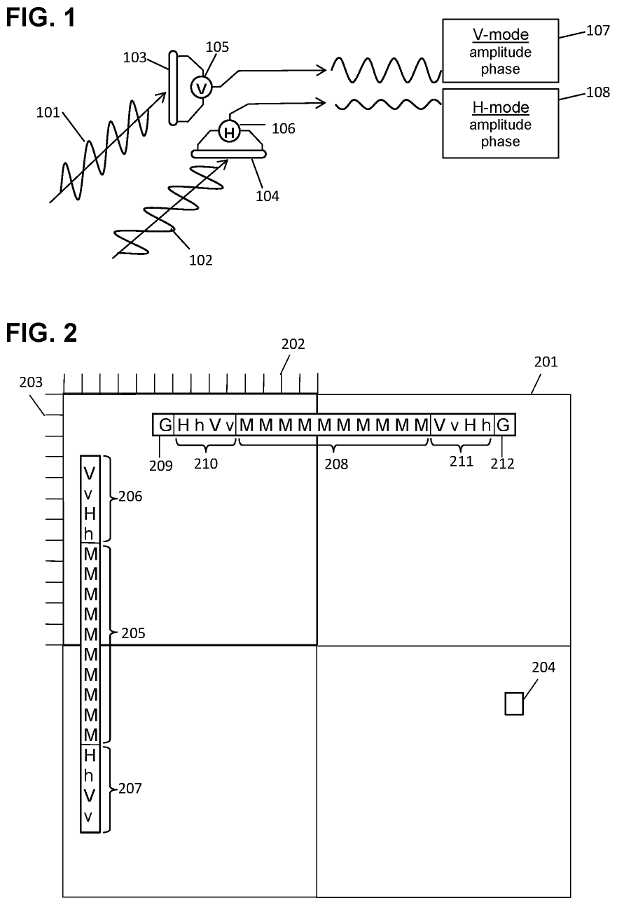

FIG. 1 is a schematic showing an exemplary embodiment of a wireless message with two linearly polarized states being received, according to some embodiments. As depicted in this non-limiting example, an electromagnetic radio wave with vertical polarization 101 and with horizontal polarization 102 components are shown, with the radio-frequency oscillation of the electric vector schematically represented as sine waves. As is well known in physics, other polarizations are possible including diagonal orientations, circular and elliptical polarizations, and other forms, all of which will be ignored herein.

Also shown are antenna elements configured to selectively receive the vertical 103 or horizontal 104 electric field oscillations. Amplifiers and filters and other electronics are suggested by the “V” and “H” elements 105, 106 which provide V-mode and H-mode components or signals 107, 108 that can be measured by, for example, frequency down-shifters, filters, RF mixers, and ADCs among other electronics. The transmitter antenna (not shown) may include similar or analogous antenna elements for transmitting the two polarizations, configured separately but transmitted simultaneously.

Since the vertical and horizontal polarization components are orthogonal, they can both be employed to carry information in a message. In practice, however, some degree of polarization mixing (“crosstalk”) is inevitable, due to diffraction and scattering in propagation as well as nonselectivity of the transmission and reception antenna elements. Therefore, the transmitter may include a polarization-demodulation reference proximate to a message, so that the receiver can determine the polarization mixing as well as the modulation levels (amplitude and phase levels, for example) and thereby demodulate the message including both polarizations. For example, the polarization-demodulation reference may include resource elements configured with a maximum amplitude of the modulation scheme transmitted in the vertical polarization and zero or substantially zero transmission in the horizontal polarization, and/or resource elements with the maximum signal in the horizontal with zero or substantially zero amplitude in the vertical. The receiver can then determine, from the amplitude and phase of the nominally zero-power component, how much of the transmitted signal appears as crosstalk, and can mitigate the crosstalk or polarization mixing by subtracting a crosstalk value from each modulated value. For example, the receiver can determine the crosstalk by receiving a polarization-demodulation reference in which one polarization is fully powered and the other polarization is not powered. The receiver can divide the signal observed in the nominally unpowered polarization by the other signal observed in the powered polarization, thereby deriving a crosstalk ratio. The receiver can then correct each message element by multiplying the crosstalk ratio times the observed amplitude in one polarization and subtracting that product from the other polarization, and vice-versa for the reverse crosstalk. In this context, “substantially zero” means zero to within a measurement error.

FIG. 2 is a schematic showing an exemplary embodiment of a resource grid with polarization-encoded messages, according to some embodiments. As depicted in this non-limiting example, a resource grid 201 includes two slots demarked by symbol-times 202 and two resource blocks demarked by subcarriers 203. A single resource element is shown as 204. A frequency-spanning (multiple subcarriers at a single symbol-time) message 205 includes a leading 206 and trailing 207 polarization-demodulation references. A time-spanning (multiple symbol-times at a single subcarrier) message 208 includes a leading gap 209 of zero transmission, a leading polarization-demodulation reference 210, a trailing polarization-demodulation reference 211, and a final gap 212. Individual resource elements are labeled according to their signal content. G stands for a gap of no transmission. V and v represent transmission of the maximum and minimum modulation levels (such as amplitude or phase levels) of the modulation scheme, transmitted in the vertical polarization only, while avoiding transmitting power in the horizontal. H and h represent transmission of the maximum and minimum levels in the horizontal polarization component, with zero transmission in the vertical component. Message elements are labeled M and are modulated in both vertical and horizontal polarizations according to the binary bits of the message. For example, if the modulation scheme is QPSK with two polarizations, the first two bits of the message may be used to set the phase of the vertical polarization component, and the next two bits for the horizontal component, of the first message element. Subsequent message elements may be modulated according the the pair-wise bits of the message in a similar way, thereby providing 4 pits per message element, without resorting to amplitude modulation.

The gaps 209, 212 may enable the receiver to identify the start and end of the message. The gaps 209, 212 may also enable the receiver to evaluate noise and interference separately for the two polarizations, at the beginning and end of each message. The polarization-demodulation references 206, 207, 210, 211 may enable the receiver to update a calibration set of the modulation levels, such as amplitude and phase levels, for the two polarizations separately. In particular, by exhibiting the maximum and minimum amplitudes of the modulation scheme for each polarization orientation, the polarization-demodulation references may enable the receiver to quantify and largely mitigate noise and interference, including noise and interference that may vary across the message in time (for message 208) or in frequency for message 205). In addition, by exhibiting those maximum and minimum amplitudes for each polarization separately, with zero power in the orthogonal component, the polarization-demodulation references may enable the receiver to evaluate the vertical-to-horizontal crosstalk and horizontal-to-vertical crosstalk separately, and thereby to adjust the detected message signals for clearer separation of the polarization components. In addition, the polarization-demodulation references may exhibit specific phase levels of the modulation scheme, such as 0 and 180 degrees, or the maximum and minimum polarization levels, or other predetermined phase levels, which the receiver can then use to calculate intermediate phase levels and to mitigate noise and interference and polarization mixing that may distort the detected phase of the message elements. In addition, by using different sequences for the leading and trailing polarization-demodulation references (such as “VvHh” versus “HhVv” as shown), the transmitter may thereby assist the receiver in determining the start and end of each message.

In some embodiments, the modulation scheme may include classical amplitude-phase modulation in which each message element is modulated according to one of several predetermined amplitude levels and one of several predetermined phase levels, each level selected according to the bits of the associated message element, in which case the polarization-demodulation references may exhibit the maximum and minimum amplitude levels and certain phase levels of the modulation scheme, as mentioned. In other embodiments, the modulation scheme may include pulse-amplitude modulation PAM in which the message bits are divided into two signals, the I-branch and Q-branch signals, which are then amplitude modulated and transmitted with a 90 degree phase difference. In that case, the V symbol in the figure may indicate the maximum amplitude level on both the I and Q branches in the vertical polarization, and the v symbol may indicate the minimum amplitude level on both branches with vertical polarization, and likewise for H and h on the horizontal polarization. The receiver, upon receiving and analyzing the polarization-demodulation reference, can determine the maximum and minimum amplitudes for each polarization separately, calculate intermediate amplitude or phase levels if any, quantify crosstalk in both directions, and update the calibration set of amplitude and phase levels for each polarization orientation at each end of the message, and thereby mitigate most types of noise and interference and polarization mixing.

In some embodiments, the transmitter may encode the bits of the message in the vertical and horizontal polarizations according to a formula, such as the first two bits encoded in the vertical component and the next two bits encoded in the horizontal component of a message element, and continuing similarly for each message element.

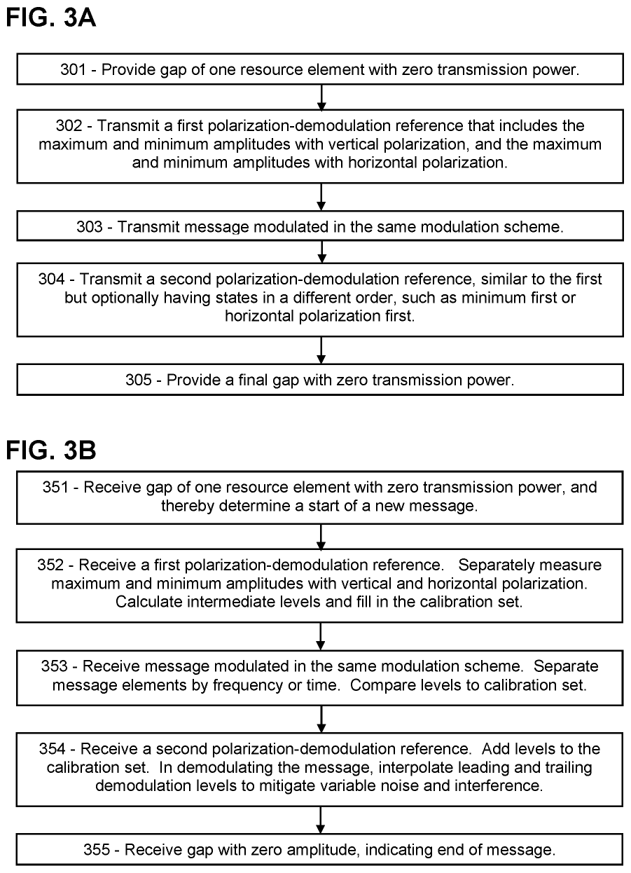

FIG. 3A is a flowchart showing an exemplary embodiment of a procedure for transmitting a message with polarization encoding, according to some embodiments. As depicted in this non-limiting example, at 301 the transmitter provides a gap of one resource element with zero transmitted power. For a frequency-spanning message, the transmitter transmits a sum-signal (including all the subcarrier signals mixed together). In either case, gap has zero amplitude transmitted in one subcarrier and one symbol-time at the I and Q phases for both V and H polarizations, in this example. At 302, the transmitter transmits a first polarization-demodulation reference exhibiting the maximum and minimum modulation levels (such as amplitude levels) of the modulation scheme, in the vertical and horizontal polarizations separately.

At 303, the transmitter transmits the message in which each message element is modulated according to the same modulation scheme as the polarization-demodulation references. Each message element is modulated and allocated to the horizontal or vertical polarization according to a formula. The formula may depend on the modulation scheme, the number of bits encoded in each modulation state, or the number of states in the modulation scheme. For example, QPSK with polarization (“QPSK+P”) may encode two bits per polarization or 4 bits per message element, in which case bits 1 and 2 may be encoded in the phase of the vertical polarization while bits 3 and 4 may be encoded in the phase of the horizontal polarization of the first message element, and continuing in the same way for the succeeding message elements.

At 304, the transmitter transmits the second polarization-demodulation reference, followed by a gap at 305. The order of states, the leading and trailing polarization-demodulation references may be different, thereby assisting the receiver in determining the start and end of the message.

FIG. 3B is a flowchart showing an exemplary embodiment of a procedure for receiving a message with polarization encoding, according to some embodiments. As depicted in this non-limiting example, at 351 a receiver receives or detects a resource element transmitted with zero amplitude (within measurement error) and determines that a message is forthcoming. At 352, the receiver receives a polarization-demodulation reference and determines therefrom the levels (such as amplitude levels) of the modulation scheme. The as-received resource elements include any contributions from noise and interference and polarization mixing, for each polarization state. The receiver then updates a calibration set with those modulation levels, and calculates any intermediate levels by, for example, interpolation. At 353, the receiver receives the message elements and demodulates the message elements by measuring the amplitude and optionally phase values of each polarization of the received signal for each message element, and by comparing those values to the modulation levels in the calibration set.

At 354, the receiver receives the trailing polarization-demodulation reference, in this case encoded to indicate the end of the message, and at 355 a final gap.

In some embodiments, the receiver may wait to demodulate the message until after receiving the trailing polarization-demodulation reference. The receiver can then calculate, for each message element, an interpolated set of modulation levels by weighted averaging or interpolation of the modulation levels between the leading and trailing demodulation references, that is, weighting the levels according to the position of each message element. The receiver may thereby mitigate time-dependent or frequency-dependent interference more precisely than absent the interpolation, according to some embodiments.

In some embodiments, the receiver may measure the crosstalk according to the polarization-demodulation reference elements. For example, the receiver may measure the (usually small) signal in the horizontal polarization component when only the vertical component is powered, and vice-versa when the horizontal component is powered. The receiver may thereby determine the amplitude of the polarization mixing, in both directions. In addition, the receiver can determine if the crosstalk signal is in phase with the powered polarization component or is phase-shifted relative to it. Then, when receiving and demodulating the message elements, the receiver can subtract the calculated crosstalk signal from each polarization component, and can then compare the remaining amplitude (and optionally phase) values to the amplitude and phase levels of the modulation scheme, as recorded in the calibration set from the polarization-demodulation reference elements.

In some embodiments, the receiver may digitize (or repeatedly measure) the V-mode and H-mode signals of a frequency-spanning message using, for example, a fast ADC (analog-to-digital converter), optionally with a frequency down-shifter, and may store those measurements in a memory for subsequent analysis. Then, after receiving and digitizing both polarization components during a symbol-time, the receiver may use analog or digital means to extract the signal at each subcarrier frequency for each polarization component, and measure therefrom the amplitude and/or phase values of the message element occupying that subcarrier. If one or more polarization-demodulation reference is included in the same symbol-time, or a closely proximate location, then the receiver can update the modulation levels in the calibration set first, and then determine the modulation state of each message element by comparing the amplitude or phase modulation values of the message element to the modulation levels in the calibration set. In addition, if the polarization-demodulation reference includes reference elements with transmitted power in only one polarization component, and zero transmission in the other component, then the receiver can determine a crosstalk ratio according to the amplitude measured in the unpowered component divided by the powered component amplitude, and multiply that ratio by the amplitude of the message element in the same component, thereby determining the expected crosstalk signal. The receiver can then subtract that product from the other polarization component at the same message element, and may thereby correct for polarization mixing.

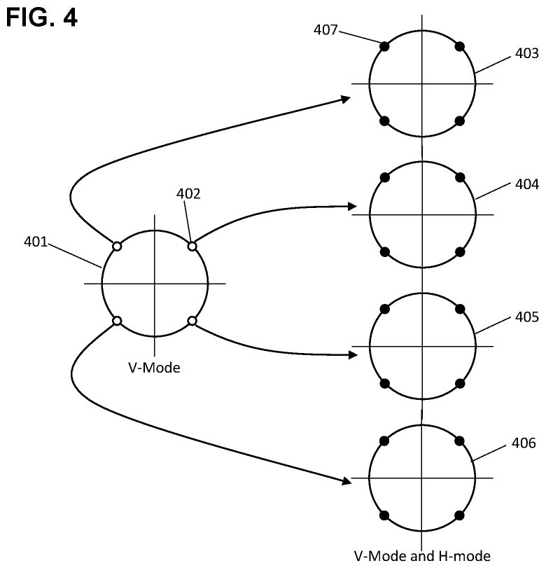

FIG. 4 is a graphic showing an exemplary embodiment of a QPSK modulation scheme with polarization encoding, according to some embodiments. As depicted in this non-limiting example, a QPSK phase chart includes a circle 401 representing an amplitude, and four modulation states 402 depicted as hollow dots, spaced at 90-degree intervals around the amplitude circle 401, starting at 45 degrees in this case. These four states 402 can be transmitted in the vertical polarization mode alone, conveying 2 bits per message element. Thus the V-mode states 402 represent normal QPSK with a single polarization, such as vertical.

If horizontal polarization is added to the modulation scheme, each of the four V-mode states 402 can be multiplexed with one of the four H-mode states, respectively. Each V-mode state 402 thereby leads to four multiplexed H+V states 407 as shown in the four multiplexed phase charts 403, 404, 405, 406. For example, the state 407 corresponds to a message element with a multiplexed H and V transmission, in this case the V-mode transmission with a 45-degree phase, multiplexed with a simultaneous H-mode transmission with 135-degree phase. The number of distinct modulation states is 4×4=16 states, which encodes 4 bits per message element. In other words, polarized QPSK+P provides the same data rate as prior-art single-polarization 16QAM, but without the amplitude modulation. Since QPSK is employed in many situations in 5G, such as control messages, those messages could be half as long if encoded using both polarization components, as disclosed herein, thereby saving time and bandwidth, according to some embodiments.

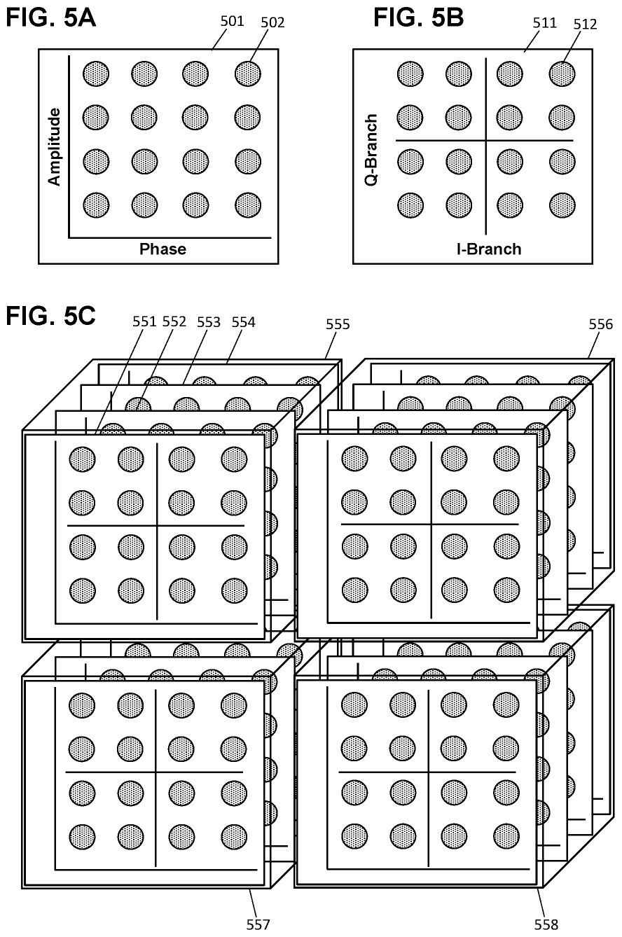

FIG. 5A is a graphic showing an exemplary embodiment of a 16QAM modulation scheme with classical amplitude-phase modulation, according to some embodiments. As depicted in this non-limiting example, a modulation table 501 shows the sixteen states 502 of a 16QAM modulation scheme according to the amplitude and phase of each state 502. A each message element encodes 4 bits of information, that is, 2 bits for amplitude modulation in 4 levels, multiplexed with 2 bits for phase modulation in 4 levels, for a total of 4 bits in 16 distinct modulation states. The amplitude levels in classical amplitude-phase modulation generally extend from a minimum level, at the bottom of the table, to a maximum level at the top. The phase is a circular parameter, with phase levels equally separated in 0-360 degrees. The depicted states 502 may be termed “unpolarized” since they do not depend on the polarization, or are transmitted in one polarization direction such as vertical.

FIG. 5B is a graphic showing an exemplary embodiment of a 16QAM modulation scheme with pulse-amplitude modulation, according to some embodiments. As depicted in this non-limiting example, a constellation table 511 shows the sixteen states 512 of a 16QAM modulation scheme with PAM, according to the amplitudes of the I-branch and Q-branch signals of each state. The I-branch amplitudes include −3, −1, +1, +3 amplitude units. (An “amplitude unit” is an arbitrary units of signal amplitude.) The Q-branch has similar levels. Each message element is formed by the addition of one I-branch signal plus one Q-branch signal with a 90-degree phase shift. Each message element can carry 4 bits of information, 2 for the I-branch and 2 for the Q-branch. The states 512 are unpolarized, in that they can be provided on either the V-mode or the H-mode, or other polarization.

FIG. 5C is a graphic showing an exemplary embodiment of a polarization-encoded 16QAM modulation scheme including modulation of both vertical and horizontal polarizations, according to some embodiments. As depicted in this non-limiting example, multiplexing the two polarization components can greatly increase the number of states. The examples of FIGS. 5A and 5B may represent the V-mode states when the H-mode remains at zero power or is unused. In contrast, FIG. 5C includes states in which each of the vertical and horizontal polarizations can have any one of the sixteen modulation states of FIG. 5A or 5B in each of the two multiplexed polarizations, thereby producing a total of 16×16=256 distinct modulation states. A single “page” 551 includes sixteen states such as those of FIG. 5A or 5B, which in this graphic may be modulated according to classical amplitude-phase modulation or pulse-amplitude modulation (both are symbolically indicated). In addition, the four “pages” 551, 552, 553, 554 represent states in which one of the polarizations (the vertical, say) is modulated according to the sixteen states as mentioned, and in addition the horizontal polarization signal is modulated according to one of the modulation variables, such as the I-branch amplitude for PAM or the phase for classical modulation. Likewise, the four “boxes” 555, 556, 557, 558 represent modulation in the horizontal polarization signal according to the other modulation parameter, such as the Q-branch amplitude in PAM or the signal amplitude in classical modulation. When the two polarization components are multiplexed together, the pages and boxes together represent the possible modulation states. The transmitter can separately modulate the vertical and horizontal polarization signals according to each of the amplitude and phase levels of a classical modulation scheme or the I and Q branch amplitudes of a PAM scheme, in each of the 256 states depicted.

The receiver can then receive a message element, including both vertical and horizontal polarization signals, and can measure the modulation levels in each polarization component separately. For example, the receiver can measure the amplitude and phase for classical modulation, or the I and Q branch amplitudes for PAM, in each of the two polarization signals. The receiver can then compare each of the measured modulation values to the calibration set, which includes the modulation levels previously provided in the polarization-demodulation reference elements, and can thereby determine which of the 256 states is represented in the message element. Such a polarization-encoded message element can thereby carry 8 bits of information, which is twice the information density of unpolarized 16QAM. Therefore, messages so encoded can be half as long (in time or in bandwidth) as would be required to transmit the same data, absent polarization encoding.

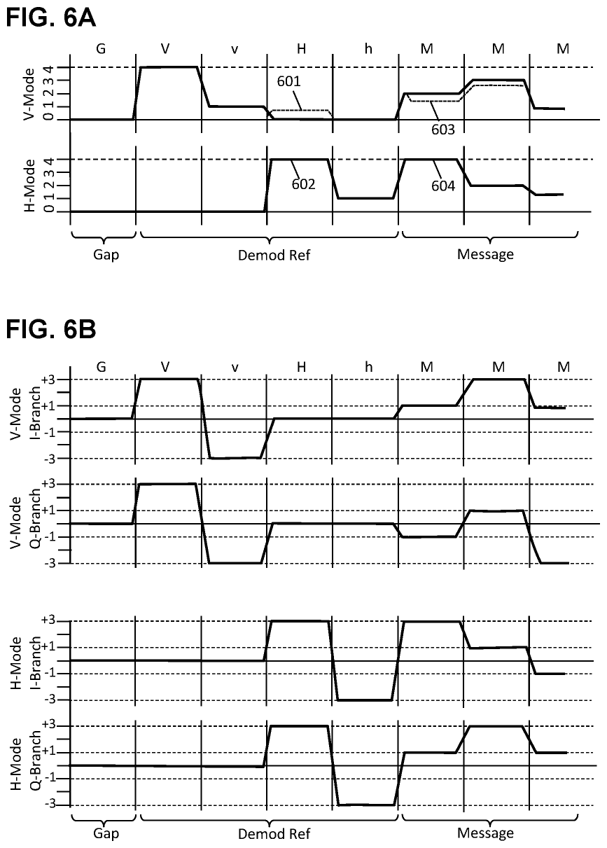

FIG. 6A is a graphic showing an exemplary embodiment of a polarization-encoded 16QAM message including a demodulation reference in classical amplitude-phase modulation, according to some embodiments. As depicted in this non-limiting example, a message such as described in FIG. 2 is presented in more detail, including a gap, a short-form polarization-demodulation reference, and a portion of the message, each resource element encoded separately in vertical and horizontal polarization modes. In this example, the modulation is 16QAM with classical amplitude-phase modulation. Although the message is shown spread out horizontally, this does not imply that the message is time-spanning; the example applies equally to a frequency-spanning message. Resource elements are delineated by vertical lines, and four amplitude levels (1-4 units) are demarked at the left axis, for each V and H polarization mode. A dashed line indicates a 4-unit amplitude. The transmitted amplitudes are traced by heavy lines, as in an oscilloscope display, with time horizontal.

The first resource element is a gap “G” of zero transmission (zero amplitude) in both V and H modes. The gap is followed by a polarization-demodulation reference with four resource elements. The demodulation reference exhibits the maximum and minimum amplitudes in the vertical and horizontal polarizations, as indicated by the “V v H h” labels across the top. The modulation states correspond to those in FIG. 2. The second resource element (V) shows a maximum transmission of 4 units in the vertical polarization and zero in the horizontal polarization, followed by (v) the minimum amplitude level of 1 unit in the vertical and still zero in the horizontal. Then in the fourth and fifth resource elements (H and h), the horizontal mode has the maximum and minimum values, with zero in the vertical polarization. The phase levels may also be exhibited in the same demodulation reference by multiplexing phase with amplitude. For example, the minimum and maximum phase levels may be exhibited in the demodulation reference element, or all four phase levels of the modulation scheme may be exhibited explicitly in the four resource elements.

The polarization-demodulation reference in this example includes resource elements with zero signal transmission in one of the polarization components, that is, zero amplitude in the horizontal polarization while the vertical polarization is transmitted, and then zero transmission in the vertical polarization while the horizontal polarization is transmitted. The receiver can determine the maximum and minimum amplitude levels in the vertical and horizontal polarization components separately, and can then fill in any intermediate amplitudes (at 2 and 3 amplitude units, for example) by interpolation. The receiver can also measure how much polarization crosstalk occurs by monitoring the received signal in one polarization, when the other polarization is powered. The receiver can then prepare corrections or mitigations by dividing the observed crosstalk by the amplitude of the powered component, thereby getting a crosstalk ratio. Then the receiver can calculate a crosstalk amount for each message element by multiplying the crosstalk ratio by the amplitude transmitted in one polarization, and then subtract the polarization amount from the other polarization component. By subtracting the proportional crosstalk amount from each component, the receiver can obtain an improved SNR and reduced fault rates, according to some embodiments.

The figure includes an example of crosstalk between polarizations and its mitigation. In the “H” reference element, the received signal in the V-mode is not zero as expected, but instead is shown by a dotted line 601 as a low non-zero amplitude. This is due to crosstalk or polarization mixing, coming from the full-amplitude signal 602 in the horizontal component and somehow being partially added to the vertical signal. The receiver can mitigate this distortion by calculating a crosstalk ratio, equal to the observed V-mode amplitude 601 divided by the observed H-mode amplitude 602, in a reference element that is known to have zero transmission in the V-mode. The receiver can also calculate a complementary crosstalk ratio for V-mode mixing into H-mode, but in this example there doesn't seem to be any. Then, when demodulating the message elements, the receiver can determine the amplitude of the H-mode signal 604, multiply by the crosstalk ratio, and subtract that product from the observed V-mode signal, as shown as 603, thereby largely canceling the polarization crosstalk if present.

In addition, the receiver can measure the background noise and interference, in both polarization components, by monitoring the received signal during the gap. For example, the receiver can compare the amplitude and phase of the V and H components, in the leading and the trailing gaps, and can compare those values to determine whether the interference has changed significantly during the time of the message (for time-spanning) or the bandwidth (for frequency-spanning) messages. If the background signals detected during the leading and trailing gaps differ, the receiver may determine where in the message the background changed, and mitigate accordingly. For example, if the background changes substantially in the course of the message, the receiver may measure how closely each message element's modulation values match the calibration set levels, and may thereby determine when in the message the change in interference occurred as a sudden or gradual decrease in modulation quality. Then the receiver can apply the calibration set of the leading demodulation reference for demodulating the first portion of the message, before the background change, and can apply the second calibration set derived from the trailing demodulation reference to demodulate the message elements occurring after the change in backgrounds.

In the figure, a few message elements are shown, demarked as “M”, with the vertical and horizontal polarizations varying among the four amplitude levels according to the message content. The message amplitudes are not restricted to the two maximum and minimum levels exhibited in the demodulation reference, because the receiver can calculate the intervening amplitude, and phase, levels by interpolation.

FIG. 6B is a graphic showing an exemplary embodiment of a polarization-encoded 16QAM message including a demodulation reference in pulse-amplitude modulation, according to some embodiments. As depicted in this non-limiting example, The transmissions in the I and Q branches are shown for both vertical and horizontal polarizations, in a PAM message and a polarization-demodulation reference. Resource elements are marked with vertical lines, and the amplitude levels (−3, −1, +1, +3 units) are delineated with dashed lines. Zero amplitude is indicated by a solid horizontal line.

The first resource element is a gap G with zero amplitude transmitted in both branches and both polarizations. Then four resource elements (labeled V v H h) exhibit the maximum and minimum amplitude levels (+3 and −3 units) in both I and Q branches of the vertical polarization (V v), followed by the maximum and minimum amplitude levels on the I and Q branches with horizontal polarization (H h). The message elements M then follow. The message elements are modulated with the various branch and polarization amplitude levels according to the data in each message element. During the gap G, the receiver can determine the noise and interference in each branch and polarization component. The receiver can then measure the I and Q amplitudes during each resource element of the demodulation reference, and can interpolate between the exhibited ±3 unit amplitude levels to determine the intermediate amplitude levels, which in this case are the +1 and −1 unit amplitude levels. The receiver can then fill in the calibration set for each branch and each polarization. In addition, the receiver can measure the signal amplitude in the H component when the V component is powered, and vice-versa, and thereby determine how much crosstalk is present. The receiver can demodulate the message elements by measuring the amplitude of each received signal on the I and Q branches, and at V and H polarizations, then correct for the observed crosstalk, and then compare to the amplitude levels of the calibration set by selecting whichever amplitude level in the calibration set most closely matches the received amplitude values, by branch and polarization. The receiver can thereby determine the message content, with noise and interference and polarization crosstalk largely mitigated. Due to the high information content in each message element, the message consumes only one-half as many resources as would be required if the message were transmitted on the vertical polarization alone.

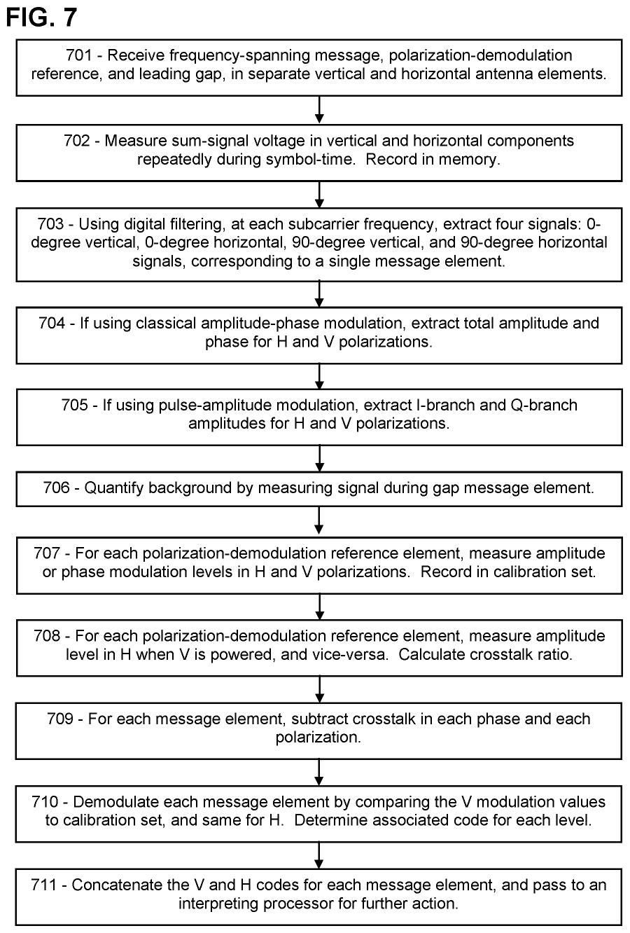

FIG. 7 is a flowchart showing an exemplary embodiment of a procedure for receiving and processing a polarization-encoded message, according to some embodiments. As depicted in this non-limiting example, at 701 a receiver receives a frequency-spanning (multiple subcarriers at a single symbol-time) message with a leading gap and a polarization-demodulation reference. The vertical and horizontal polarization components are received in two separate antenna elements. At 702, the receiver measures the voltage on each of the horizontal and vertical antenna elements versus time. The voltages represent a sum-signal due to all of the subcarrier signals within the received bandwidth, added together by linear superposition. Typically the sum-signal is a complicated wave-like signal, which includes all the information in the subcarrier signals intermingled. In this case, the receiver digitizes the sum-signal by repeatedly measuring the H and V voltages (optionally with frequency down-shifting) using a fast ADC, for example, and recording the H and V data in a memory for subsequent analysis. At 703, after the symbol-time has finished, the receiver extracts each subcarrier signal from the H and V components using digital filtering or other analog or digital means for extracting one frequency signal from a composite wave measurement. In this case, the digital filtering is phase-dependent, specifically extracting the 0-degree component of the subcarrier signal separately from the 90-degree component in the vertical polarization, and likewise for the horizontal polarization. The receiver extracts these phased and polarized signals for each subcarrier frequency, including the gap, the polarization-demodulation reference, and the message elements.

At 704, if the modulation scheme is classical amplitude-phase modulation, the receiver can combine the phased signals to determine the subcarrier signal amplitude and phase for each polarization component. At 705, if the modulation scheme is pulse-amplitude modulation, the receiver can measure the I-branch and Q-branch amplitudes, for the V and H components, according to the extracted phased data. In either case, at 706 the receiver can measure the background noise and interference level by determining the received amplitude during the gap subcarrier, since the transmitter is silent at that time and frequency. The observed signal in the gap is also a measure of the spill-over from adjacent subcarriers, due for example to an insufficient cyclic prefix or other problem.

At 707, the receiver can analyze the polarization-demodulation reference elements by measuring the signal amplitudes in the vertical and horizontal components, representing the I and Q branch amplitudes (or the classical amplitude and phase, if used). The receiver then records the measured modulation levels in a calibration set, and may also fill in any intermediate modulation levels of the modulation scheme by interpolation between the minimum and maximum levels exhibited. At 708, also during the polarization-demodulation reference elements, the receiver can calculate a crosstalk ratio by measuring the observed amplitude in a polarization component that is known to have zero transmission while the other polarization component is fully powered. The crosstalk ratio is the observed amplitude in the nominally-zero component, divided by the observed amplitude in the powered component. The receiver can determine a crosstalk ratio for V mixing into H, or H mixing into V, and for each 0 and 90 degree phase separately. At 709, the receiver subtracts the crosstalk from each message element by subtracting, from a first polarization signal, a value obtained by multiplying the crosstalk ratio times the amplitude observed in the opposite polarization signal. As mentioned, separate ratios and subtractions may be applied for each phase and each polarization component.

At 710, the receiver demodulates each message element by comparing the vertical polarization signal amplitude at zero degrees to the corresponding amplitude levels in the calibration set, selecting the closest match, and assigning to that message element the code or number associated with the selected modulation level. Proceeding, the receiver can do the same comparison and selection and code assignment for the other phase and the other polarization component, typically deriving four demodulation codes for each message element. For example, the various modulation levels in the calibration set may be assigned binary numbers such as 00, 01, 10, and 11 for four amplitude levels, and those numbers may be concatenated to generate a demodulated version of the message. At 711, the concatenated number string is passed to an interpreting processor which is expected to know how to determine the message content from it.

The disclosed systems and methods, implemented in certain embodiments, can thereby provide improved information density in communications by enabling additional modulation states in orthogonal polarization components, reduced latency or bandwidth by completing messages in fewer message elements, and improved network operation overall by quantitatively mitigating polarization crosstalk, while also mitigating noise and external interference, according to some embodiments.

The wireless embodiments of this disclosure may be aptly suited for cloud backup protection, according to some embodiments. Furthermore, the cloud backup can be provided cyber-security, such as blockchain, to lock or protect data, thereby preventing malevolent actors from making changes. The cyber-security may thereby avoid changes that, in some applications, could result in hazards including lethal hazards, such as in applications related to traffic safety, electric grid management, law enforcement, or national security.

In some embodiments, non-transitory computer-readable media may include instructions that, when executed by a computing environment, cause a method to be performed, the method according to the principles disclosed herein. In some embodiments, the instructions (such as software or firmware) may be upgradable or updatable, to provide additional capabilities and/or to fix errors and/or to remove security vulnerabilities, among many other reasons for updating software. In some embodiments, the updates may be provided monthly, quarterly, annually, every 2 or 3 or 4 years, or upon other interval, or at the convenience of the owner, for example. In some embodiments, the updates (especially updates providing added capabilities) may be provided on a fee basis. The intent of the updates may be to cause the updated software to perform better than previously, and to thereby provide additional user satisfaction.

The systems and methods may be fully implemented in any number of computing devices. Typically, instructions are laid out on computer readable media, generally non-transitory, and these instructions are sufficient to allow a processor in the computing device to implement the method of the invention. The computer readable medium may be a hard drive or solid state storage having instructions that, when run, or sooner, are loaded into random access memory. Inputs to the application, e.g., from the plurality of users or from any one user, may be by any number of appropriate computer input devices. For example, users may employ vehicular controls, as well as a keyboard, mouse, touchscreen, joystick, trackpad, other pointing device, or any other such computer input device to input data relevant to the calculations. Data may also be input by way of one or more sensors on the robot, an inserted memory chip, hard drive, flash drives, flash memory, optical media, magnetic media, or any other type of file —storing medium. The outputs may be delivered to a user by way of signals transmitted to robot steering and throttle controls, a video graphics card or integrated graphics chipset coupled to a display that may be seen by a user. Given this teaching, any number of other tangible outputs will also be understood to be contemplated by the invention. For example, outputs may be stored on a memory chip, hard drive, flash drives, flash memory, optical media, magnetic media, or any other type of output. It should also be noted that the invention may be implemented on any number of different types of computing devices, e.g., embedded systems and processors, personal computers, laptop computers, notebook computers, net book computers, handheld computers, personal digital assistants, mobile phones, smart phones, tablet computers, and also on devices specifically designed for these purpose. In one implementation, a user of a smart phone or Wi-Fi-connected device downloads a copy of the application to their device from a server using a wireless Internet connection. An appropriate authentication procedure and secure transaction process may provide for payment to be made to the seller. The application may download over the mobile connection, or over the Wi-Fi or other wireless network connection. The application may then be run by the user. Such a networked system may provide a suitable computing environment for an implementation in which a plurality of users provide separate inputs to the system and method.

It is to be understood that the foregoing description is not a definition of the invention but is a description of one or more preferred exemplary embodiments of the invention. The invention is not limited to the particular embodiments(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. For example, the specific combination and order of steps is just one possibility, as the present method may include a combination of steps that has fewer, greater, or different steps than that shown here. All such other embodiments, changes, and modifications are intended to come within the scope of the appended claims.

As used in this specification and claims, the terms “for example”, “e.g.”, “for instance”, “such as”, and “like” and the terms “comprising”, “having”, “including”, and their other verb forms, when used in conjunction with a listing of one or more components or other items, are each to be construed as open-ended, meaning that the listing is not to be considered as excluding other additional components or items. Other terms are to be construed using their broadest reasonable meaning unless they are used in a context that requires a different interpretation.

1. A method for transmitting a wireless message, the method comprising:
encoding, according to a modulation scheme, a first set of bits of the message in a first polarization component;
encoding, according to the modulation scheme, a second set of bits of the message in a second polarization component;
transmitting the first polarization component on one or more first antenna elements; and
transmitting the second polarization component on one or more second antenna elements.

2. The method of claim 1, wherein the message is transmitted according to 5G or 6G technology.

3. The method of claim 1, wherein the first and second polarization components are orthogonal.

4. The method of claim 3, wherein the first polarization component includes a vertically oriented oscillating electric field and the second polarization component includes a horizontally oscillating electric field.

5. The method of claim 1, further comprising transmitting, proximate to the message, a polarization-demodulation reference comprising at least a first predetermined signal transmitted on the first polarization component, and at least a second predetermined signal transmitted on the second polarization component.

6. The method of claim 5, wherein the first predetermined signal comprises a maximum amplitude level of the modulation scheme and a minimum amplitude level of the modulation scheme, and the second predetermined signal comprises the maximum amplitude level of the modulation scheme and the minimum amplitude level of the modulation scheme.

7. The method of claim 5, further comprising:
while transmitting the first predetermined signal on the first polarization component, avoiding transmitting power on the second polarization component; and
while transmitting the second predetermined signal on the second polarization component, avoiding transmitting power on the first polarization component.

8. The method of claim 5, further comprising:
while transmitting the first predetermined signal on the first polarization component, transmitting zero or substantially zero power on the second polarization component; and
while transmitting the second predetermined signal on the second polarization component, transmitting zero or substantially zero power on the first polarization component;
wherein substantially zero means zero to within a measurement uncertainty.

9. The method of claim 1, further comprising:
providing, proximate to the message, at least one resource element having zero or substantially zero transmission, wherein substantially zero means zero within a measurement uncertainty.

10. Non-transitory computer-readable media in a wireless receiver, the media containing instructions that when executed in a computing environment cause a method to be performed, the method comprising:
providing a first antenna element for receiving radio waves with an electric field oscillation in a vertical direction, and a second antenna element for receiving radio waves with the electric field oscillation in a horizontal direction;
receiving a message comprising message elements modulated according to a modulation scheme, each message element comprising a vertical polarization signal on the first antenna element and a horizontal polarization signal on the second antenna element;
for each message element, measuring a first amplitude or phase value of the vertical polarization signal and a second amplitude or phase value of the horizontal polarization signal;
for each message element, comparing the first amplitude or phase value to one or more predetermined amplitude or phase levels of the modulation scheme and selecting the predetermined amplitude or phase level closest to the measured first amplitude or phase value; and
for each message element, comparing the second amplitude or phase value to the one or more predetermined amplitude or phase levels of the modulation scheme and selecting the predetermined amplitude or phase level closest to the measured second amplitude or phase value.

11. The media of claim 10, the method further comprising:
associating, with each predetermined amplitude or phase level of the modulation scheme, a code or number, respectively;
assigning, to each message element, a first code or number associated with the first amplitude or phase level, concatenated with a second code or number associated with the second amplitude or phase level.

12. The media of claim 10, the method further comprising:
receiving at least one polarization-demodulation reference comprising reference elements modulated according to the modulation scheme;
for each reference element, measuring a vertical polarization amplitude or phase level and a horizontal polarization amplitude or phase level; and
recording each measured vertical polarization amplitude or phase level and each measured horizontal polarization amplitude or phase level in a calibration set comprising the predetermined amplitude or phase levels of the modulation scheme.

13. The media of claim 12, the method further comprising:
calculating one or more intermediate amplitude or phase level by interpolating between two of the measured horizontal or vertical polarization amplitude or phase levels; and
recording the one or more intermediate amplitude or phase level in the calibration set.

14. The media of claim 12, the method further comprising:
determining a crosstalk ratio comprising mixing between the vertical and horizontal polarization signals, the determining by either:
for a particular reference element, dividing the vertical amplitude level by the horizontal amplitude level; or
for the particular reference element, dividing the horizontal amplitude level by the vertical amplitude level.

15. The media of claim 14, the method further comprising:
for each message element, subtracting, from the vertical polarization signal, the horizontal polarization signal times the crosstalk ratio; and
for each message element, subtracting, from the horizontal polarization signal, the vertical polarization signal times the crosstalk ratio.

16. The media of claim 10, the method further comprising:
receiving a gap comprising a particular resource element;
measuring a vertical polarization background level according to the first amplitude or phase value in the particular resource element; and
measuring a horizontal polarization background level according to the second amplitude or phase value in the particular resource element.

17. A wireless receiver, comprising a user device or a base station in signal communication with the user device, the wireless receiver configured to receive and demodulate a message by:
repeatedly measuring a vertical polarization signal derived from a vertically oscillating electric field, and repeatedly measuring a horizontal polarization signal derived from a horizontally oscillating electric field;
determining, from the measurements, a vertical subcarrier signal at a particular subcarrier frequency and a horizontal subcarrier signal at the particular subcarrier frequency;
measuring, according to the vertical subcarrier signal, a vertical subcarrier amplitude or phase, and measuring, according to the horizontal subcarrier signal, a horizontal subcarrier amplitude or phase; and
comparing the vertical subcarrier amplitude or phase to one or more predetermined amplitude or phase levels of a modulation scheme, and comparing the horizontal subcarrier amplitude or phase to the one or more predetermined amplitude or phase levels of the modulation scheme.

18. The wireless receiver of claim 17, wherein the modulation scheme comprises phase modulation and does not include amplitude modulation, and the comparing comprises:
comparing the vertical subcarrier phase to the predetermined phase levels; and
comparing the horizontal subcarrier phase to the predetermined phase levels.

19. The wireless receiver of claim 17, wherein the modulation scheme comprises amplitude modulation and phase modulation, and the comparing comprises:
comparing the vertical subcarrier amplitude to the predetermined amplitude levels;
comparing the vertical subcarrier phase to the predetermined phase levels;
comparing the horizontal subcarrier amplitude to the predetermined amplitude levels; and
comparing the horizontal subcarrier phase to the predetermined phase levels.

20. The wireless receiver of claim 17, wherein the modulation scheme comprises pulse-amplitude modulation comprising, for each message element, a vertical subcarrier I-branch signal, a vertical subcarrier Q-branch signal, a horizontal subcarrier I-branch signal, and a horizontal subcarrier Q-branch signal, and the comparing comprises:
comparing the vertical subcarrier I-branch signal to the predetermined amplitude levels;
comparing the vertical subcarrier Q-branch signal to the predetermined amplitude levels;
comparing the horizontal subcarrier I-branch signal to the predetermined amplitude levels; and
comparing the horizontal subcarrier Q-branch signal to the predetermined amplitude levels.
